(19) United States
(12) Patent Application Publication
(10) Pub. No.: US 2002/0128366 A1
(43) Pub. Date: Sep. 12, 2002

(54) Process for coloring vulcanized rubber with improved color durability

(76) Inventor: Gerald P. Coffey, Chagrin Falls, OH (US)

Correspondence Address: BENESCH, FRIEDLANDER, COPLAN & ARONOFF LLP, ATTN: IP DEPARTMENT DOCKET CLERK, 2300 BP TOWER, 200 PUBLIC SQUARE, CLEVELAND, OH, 44114, US

(21) Appl. No.: 10/027,087

(22) Filed: Dec. 20, 2001

Related U.S. Application Data
(60) Provisional application No. 60/257,231, filed on Dec. 21, 2000.

(51) Int. Cl. C08K 3/18; C08K 3/26; C08K 3/34

(52) U.S. Cl. 524/425; 523/346; 524/430; 524/492

(57) ABSTRACT

A process for coloring vulcanized rubber granules that exhibits improved color durability is provided. Coloring is achieved by mixing low concentrations of aqueous based organic or inorganic pigment dispersions with rubber particles for a short time. Binding colorant onto the colored rubber particles is achieved when elastomer latex is added in a second step. The resulting colored vulcanized rubber particles exhibit outstanding color stability and color abrasion resistance. Optimum color adhesion onto rubber particles is achieved by use of elastomer tailored to the type of colorant used. With organic pigments such as copper phthalocyanine, excellent color abrasion resistance to vulcanized rubber particles results when elastomers such as SBR are used. With inorganic pigments such as iron oxide, excellent color abrasion resistance results when elastomers with very low glass transition temperature (T_{g}) such as acrylic rubber are used. The process can be readily scaled to large commercial blending equipment.

### CROSS-REFERENCE WITH RELATED APPLICATIONS

This application claims the benefit of U.S. Provisional Patent Application No. 60/257,231, filed Dec. 21, 2000.

### TECHNICAL FIELD

This invention relates to the preparation of colored vulcanized rubber compositions with outstanding color stability and abrasion resistance. These compositions meet the demanding physical abuse and cushioning properties required for applications as a safety surface for playgrounds. Additionally, through the judicious choice of colorants and rubber granule sizes other applications such landscaping mulch is possible. The technical basis of the present invention centers on the use of protective elastomeric coatings that encapsulate colored rubber particles in a post addition step after the colorant has been applied. The process is especially advantageous since it enables specific tailoring of the elastomeric component to the chemical type of colorant employed as well as maximizing efficiency of the coloring process before the protective coating is applied. Independent control of the concentration of the elastomeric component relative to the colorant is an added factor that promotes color durability of the vulcanized rubber compositions.

### BACKGROUND OF THE INVENTION

Scrap tire rubber (mainly SBR) is the major supply source of vulcanized rubber in the market. To date, there are ongoing efforts to improve quality of the environment by removing scrap tires from landfills and subsequently converting them to useful products. Certain legislative initiatives are in place for targeting and removing scrap tires from the environment to improve the quality of life. These include the Tire Reclamation Act of 1997, the Waste Tire Recycling and Disposal Act of 1997, and the Tire Pile Improvement and Remediation Act of 1997. A common theme in scrap tire conversion is grinding to produce various rubber particle sizes and shapes. Some of the uses of scrap tire grinds include supplemental feedstocks to enhance the BTU fuel value of selected energy sources, backfill materials to facilitate drainage around foundations, and additives to enhance the surface characteristics of various asphalts used in road construction. Other uses include soil amendments (which provide solutions to soil compaction), building products (aerosol based roofing and weatherproofing systems), and recreational safety surfaces.

A very attractive use of scrap tire grinds is in products such as landscaping mulch and protective surfaces for playgrounds. In fact, the Consumer Product Safety Commission has given its highest rating to rubber particles as the preferred choice of material to be used on playground surfaces to protect children from falls (CPSC Publication #35, 1998). The protection offered by rubber particles against falls has been proven to be far superior to any other material commonly used for this purpose in playgrounds including wood chips, bark mulch, sand, and pea gravel. Heretofore, availability of vulcanized rubber products for landscaping mulch and playground protective safety surfaces generally has been limited to uncolored scrap tire grinds. Use of water soluble colorants compounded with a modified acrylic copolymer and Theological additives as well as formation of artificial mulch chips from thermoplastic materials have been described as efforts to address these markets.

U.S. Pat. No. 5,543,172 describes a process to color and coat vulcanized rubber particles by spraying a modified acrylic copolymer mixed with water soluble colorant and rheological additives onto rubber slivers falling by gravity flow through a drop zone. The process uses high water content relative to the concentration of rubber (at least 13 weight percent water), and a drying time of approximately 20 minutes at 200° F. for the treated rubber particles is required. The relative ratio of colorant to modified acrylic resin is approximately 1:1.

U.S. Pat. No. 5,105,577 describes a process to produce artificial mulch chips from various thermoplastics. The surface of the chips is embossed with a design that provides additional surface area that facilitates diffusion to the surrounding environment of fugitive active ingredients such as animal repellents, insecticides, and odorants. The chips can be colored to simulate bark chips from a tree.

There are methods to color non-vulcanized rubber. U.S. Pat. No. 6,036,998 describes a process to color ethylene-propylene diene monomer (EPDM) rubber granules for use as safety and athletic surfaces. In a ribbon blender carbon black EPDM rubber is treated with materials selected from a group consisting of silanes, titanates, or zirconates and a paint based on either epoxies, urethanes, or epoxy esters is added. After thorough mixing in the blender, the colored material is conveyed to a tunnel oven and dried at an internal oven temperature of approximately 450° F. between 30 minutes and 90 minutes. This procedure provides a durable and permanent color coating on the EPDM rubber.

From the above information it can be appreciated that the utility of scrap vulcanized tire grinds for large scale manufacture of landscaping mulch and playground protective surfaces would be greatly enhanced using a low cost coloring process that provides uniform coloration as well as outstanding color durability and permanence. Since utilization of these products is based on both performance and appearance, efficient coloring of scrap tire grinds would enhance aesthetic value considerably, thereby creating significant competitive advantages in the marketplace for the manufacturer.

### DISCLOSURE OF THE INVENTION

It is, therefore, an object of the present invention to provide colored vulcanized rubber particles with outstanding durability in terms of color abrasion resistance, exposure to aqueous environments, and uniform colorfastness/ultraviolet resistance.

It is another object of the present invention to provide colored vulcanized rubber materials with outstanding durability in terms of color abrasion resistance, exposure to aqueous environments, and uniform colorfastness/ultraviolet resistance for landscaping mulch and playground protective safety surface applications.

It is still another object of the present invention to provide a process for the preparation of colored vulcanized rubber products with color durability and permanence required for landscaping mulch and playground protective safety surface applications. These and other objects together with the advantages thereof over known processes to color and encapsulate rubber shall become apparent from the specification which follows and are accomplished by the invention as hereinafter described and claimed.

The present invention provides a process for the uniform coloring of vulcanized rubber granules using a wide variety of colors based on both inorganic and organic pigments. Additionally, the present invention provides a second and independent step to coat the colored vulcanized rubber granules with a protective elastomeric film. The elastomeric compositions are chosen from groups known to give durable and flexible coatings. Further, the overall performance of the elastomeric coating in providing adhesion of the colorant to vulcanized rubber particles is maximized since its choice is guided by first principles and fundamental considerations based on electronic and/or steric interactions. Other factors such as the relative flexibility of the elastomeric coating could be important in influencing the extent of colorant adhesion onto vulcanized rubber.

The present invention comprises a process for preparing colored vulcanized rubber granules comprising: adding aqueous pigment dispersion to uncolored vulcanized rubber granules; mixing the pigment and rubber granules a first predetermined period of time at ambient temperature to achieve uniform color coverage onto the vulcanized rubber granules to thereby form colored vulcanized rubber granules; adding elastomer latex to the colored vulcanized rubber granules; mixing the elastomer latex and the colored vulcanized rubber granules a second predetermined period of time at ambient temperature to achieve uniform rubber coating onto colored vulcanized rubber granules to thereby form rubber coated colored vulcanized rubber granules; and drying the rubber coated colored vulcanized rubber granules for a third predetermined period of time. The first predetermined period of time is between about 1 to 10 minutes, the second predetermined period of time is between about 3 to 8 minutes, and the third predetermined period of time is between about 2 to 10 minutes. The drying step may occur at either ambient temperature or it may be preferable to perform the drying step at a temperature range between about 90-120° C. The aqueous pigment dispersion may be added to vulcanized rubber granules that have been previously heated to about 70-95° C. in a ribbon mixer, the mixture is stirred about 5 to 10 minutes at about 70-95° C., elastomer latex is added to this mixture and stirred about 3 to 8 minutes at about 70-95° C., and the mixture is dried by stirring 10-20 minutes at about 70-95° C. The aqueous pigment dispersion may be added to vulcanized rubber particles in a concentration range of 0.01 to 5.00 weight percent with respect to the amount of rubber used. The elastomer latex may be added to vulcanized rubber particles contacted with aqueous pigment dispersion at a concentration range of 0.01 to 4.00 weight percent with respect to the amount of rubber used. The concentration of water in the mixture is in the range of 0.01 to 5.00 weight percent.

The aqueous pigment dispersion may be comprised of an organic pigment, an opacifying pigment such as titanium dioxide, zinc oxide or silicon dioxide and optionally an extender such as calcium carbonate. When the aqueous pigment dispersion is comprised of an organic pigment, the total solids content of the aqueous organic pigment dispersion is in the range of 35 to 55 weight percent. The weight ratio of the organic pigment to the total weight of organic pigment, opacifying pigment and optional extender is in the range of 0.0145 to 0.290. The organic pigment may be selected from the group consisting of phthalocyanines, chloro phthalocyanines, dioxazines, azo condensation products, isoindolinones, pyrimidinetriones, quinacridones, and diketo pyrrolopyrrols. The organic pigment may be either copper phthalocyanine or chloro copper phthalocyanine.

The aqueous pigment dispersion may be comprised of an inorganic pigment, an optional opacifying pigment such as titanium dioxide, zinc oxide or silicon dioxide and an optional extender such as calcium carbonate. Where the aqueous pigment dispersion is comprised of an inorganic pigment, the solids content of the aqueous inorganic pigment dispersion is in the range of 30 to 50 weight percent. The weight ratio of the inorganic pigment to the total weight of inorganic pigment, optional opacifying pigment and optional extender is in the range of 0.467 to 1.000. The inorganic pigment may be selected from the group consisting of inorganic metal oxides and inorganic metal oxide mixtures. The inorganic pigment may be selected from the group consisting of mixed phase oxides the ingredients of which have been chemically reacted at high temperatures and are homogeneously and ionically interdifused to form an essentially insoluble mixed metal oxide pigment crystal with a rutile crystalline matrix. The inorganic pigment may also be either iron (III) oxide of formula Fe₂O₃, hydrated iron (III) oxide of formula FeOOH, a mixture of hydrated and unhydrated iron oxides of formula Fe₂O₃/FeOOH/Fe₃O₄, chromium (III) oxide of formula Cr₂O₃, a chrome antimony titanium mixed phase oxide of formula (Ti,Cr,Sb)O₂, or a nickel antimony titanium mixed phase oxide of formula (Ti,Ni,Sb)O₂. The inorganic pigment may also be selected from the group consisting of mixed phase oxides the ingredients of which have been chemically reacted at high temperatures and are homogeneously and ionically interdiffused to form an essentially insoluble mixed metal oxide pigment crystal with a spinel crystalline matrix. In this case, the inorganic pigment may be either a cobalt titanate mixed phase oxide of formula Co₂TiO₄, a mixed phase oxide of formula CoAl₂O₄, or a cobalt chromite mixed phase oxide of formula Co(Al,Cr)₂O₄.

The elastomer latex may be either styrene/butadiene (SBR) rubber optionally modified by the addition of hydroxyl and/or carboxyl groups, polybutadiene (PBD) rubber, or acrylic rubber optionally modified by co and/or terpolymerization. If the elastomer later is an acrylic rubber, then the acrylic rubber should have a glass transition temperature (T_{g}) in the range −13° C. to −70° C.

The present invention also provides a method of preparing colored rubber particles comprising: mixing vulcanized rubber particles with an aqueous pigment dispersion to form a mixture; stirring the mixture to color coat the rubber particles to thereby form color coated rubber particles; adding an elastomer latex to the mixture to encapsulate the color coated rubber particles; and drying the encapsulated rubber particles to thereby form a protective film around the color coated rubber particles. The step of adding the elastomer latex may be a step separate from the mixing step. The amount of the aqueous pigment dispersion in the mixture is about 0.01 to 8.00 weight percent of the vulcanized rubber particles.

The pigment may comprise an organic pigment. If the pigment comprises an organic pigment, then the aqueous organic pigment dispersion has a total solids content of about 40 to 60 percent. The aqueous organic pigment dispersion may further comprise rheological agents and opacifying pigments. Also, the elastomer latex may comprise an elastomer capable of bonding with the organic pigment wherein the elastomer latex comprises styrene/butadiene rubber.

The pigment may comprise an inorganic pigment. If the pigment comprises an inorganic pigment, then the aqueous inorganic pigment dispersion has a total solids content of about 35 to 55 percent. The aqueous inorganic pigment dispersion may further comprise an opacifying pigment and an extender. Also, the elastomer latex may comprise an elastomer capable of 2.0 bonding with the inorganic pigment wherein the elastomer latex comprises a functionalized polyacrylate copolymer, an anionic polyacrylic acid, or an ester. The aqueous inorganic polymer dispersion may further comprise an anionic surfactant.

The present invention provides a playground surface material comprising: vulcanized rubber particles; a color coating covering and adhering to the vulcanized rubber particles to thereby form color coated vulcanized rubber particles; and an elastomer encapsulating the color coated vulcanized rubber particles. The color coating may comprise an organic pigment. The color coating may further comprise an opacifying pigment and/or an extender. The elastomer may comprise a styrene/butadiene rubber. The color coating may comprise an inorganic pigment. The color coating may further comprise an anionic surfactant and an opacifying pigment and/or an extender. The elastomer comprise a functionalized polyacrylate copolymer, an anionic polyacrylic acid, or an ester.

### PREFERRED EMBODIMENT OF THE INVENTION

The efficient coloring of vulcanized rubber particles and especially the attendant rubber color durability are technically challenging issues. Rubber coloring can be achieved as a consequence of electronic interactions between the colorant and the residual unsaturation and sulfur linkages in vulcanized rubber. The nature of these electronic interactions is weak since only unshared electron pairs on the sulfur atoms and/or pi-bond orbital overlap of the residual unsaturation are involved with the polar sites of the colorant; there are no direct covalent bonds formed between the colorant and the available sites on the vulcanized rubber. Steric interactions also can be important.

Because of these weak electronic interactions, it is generally observed that adhesion of colorant onto rubber particles is marginal to poor. This then leads to unsatisfactory performance of colored vulcanized rubber particles particularly with regard to important performance properties such as color abrasion resistance and color permanence when exposed to aqueous environments in applications such as protective surfaces for playgrounds and landscaping mulch. There is a considerable body of literature describing the vulcanization of elastomers to produce rubber suitable for use in tires. Sulfur vulcanization is far and away the most common approach for rubber types with properties suitable for tire applications. The mechanism for sulfur vulcanization originally was thought to be free radical, but later work points to an ionic mechanism. Regardless of the operative mechanism, there is common agreement that a key structural moiety in vulcanized rubber is

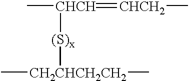

where x is a small number. Most likely there also are a few residual unsaturation sites from parts of elastomer backbones not involved in the vulcanization reaction.

Vulcanized rubber granules from scrap tire grinds are available in various sizes depending on the application. Generally the largest pieces of chunk rubber used in the present invention are irregular shapes measuring about ¾ to 1 inch with a thickness in the range of ⅛ to 3/16 inch. Long, thin pieces of vulcanized rubber (buffings) used in the present invention measure about 1 to 2 inches and have an average diameter of about 1/16 to ⅛ inch. The rubber buffings are used in admixture with the chunk rubber pieces to prepare the landscaping material. Rubber nuggets measuring about ⅜ of an inch are used for playground material. These sizes of vulcanized rubber granules are the most common used for coloring in the present invention. It is to be understood, however, that coloring and other procedures set forth in the present invention are also applicable to other sizes of vulcanized scrap tire grinds.

Both organic and inorganic pigments are used in this invention. The organic pigments offer a wide range of brilliant colors and are much more expensive than the inorganic pigments. For reasons of economy, their use is generally at much lower concentrations than the inorganic pigments. The organic pigments are conjugated structures, optionally complexed with metal atoms. Copper phthalocyanine is a very well known organic pigment, and it is used in this invention to provide brilliant blue coloration to vulcanized rubber particles. The structure of copper phthalocyanine is depicted

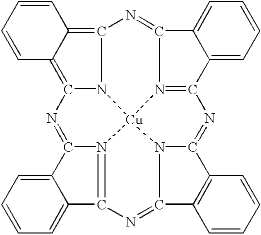

This complexed conjugated structure can exhibit electronic interactions with the vulcanized rubber structure shown above through pi-bond orbital overlap of the C═N unsaturated moieties with the residual unsaturation. Weak interactions between the aromatic nuclei of the copper phthalocyanine and the residual unsaturation of the vulcanized rubber may be possible. Interactions of the copper atom with the sulfur bonds may also be possible. Steric interactions should be minimized due to the planarity of the copper phthalocyanine molecule thereby enabling requisite proximate approach of the pigment molecule to the locus of the crosslinked vulcanized rubber structure.

A very important aspect of the present invention is the identification of efficient surfactants to promote the formation of high quality, relatively stable aqueous dispersions of pigments such as copper phthalocyanine. A high quality aqueous dispersion is essential to ensure uniform delivery of copper phthalocyanine molecules to the vulcanized rubber sites. Aqueous dispersions that are not of high quality and that are incapable of preventing premature settling/agglomeration of colorant/additives are not desired since poor, non-uniform color coverage on the rubber particle results.

Surfactants especially suitable for the purpose of promoting high quality and stable aqueous dispersions for organic pigments such as copper phthalocyanine in the present invention are those selected from groups based on alkyloxypolyethyleneoxyethanols (secondary alcohol ethoxylates) and octylphenoxypolyethoxyethanols (alkylphenol hydroxypolyoxyethylenes). Examples of the first category of nonionic surfactants are known as Tergitol 15-S-7 and Tergitol 15-S-9. These surfactants are available commercially from Union Carbide Corporation, Danbury, CT 06817-0001. Union Carbide Corporation is now a subsidiary of The Dow Chemical Company, Midland, Mich. The structure of Tergitol surfactants can be represented as

C₁₂₋₁₄H₂₅₋₂₉O(CH₂CH₂O)ₓH

where x=7-9.

Examples of the second category of nonionic surfactants are known as Triton X-45 and Triton X-100, and these materials also are available commercially from Union Carbide Corporation. The structure of Triton surfactants can be represented as

C₈H₁₇C₆H₄O(CH₂CH₂O)ₓH

where x=5-9.5.

Copper phthalocyanine exists in various crystalline modifications. Copper phthalocyanine with color index name C.I. Pigment Blue 15:3 and C.I. Pigment Blue 15 are suitable for use in the present invention.

These classes of nonionic surfactants can be used to prepare aqueous dispersions for a variety of organic pigments. They can be used singly or in admixture with each other. Depending on the overall formulations containing organic pigments, low levels of other ingredients may be required in admixture with the nonionic surfactants. Hence, in the present invention materials selected from groups such as rheological agents may be used in conjunction with the nonionic surfactants. Suitable Theological agents are hydroxyethyl cellulose, carboxymethyl cellulose, and bentonite clays. Other materials such as lecithin, polyvinyl pyrrolidone, and selected anionic surfactants may be incorporated with the nonionic surfactants.

In addition to copper phthalocyanine to produce blue vulcanized rubber particles, other organic pigments are employed in the present invention. Chlorinated copper phthalocyanine (color index name C.I. Pigment Green 7) is copper phthalocyanine containing 12-14 chlorine atoms on the aromatic nuclei. The resulting vulcanized particles are colored a medium green. An organic pigment producing a brilliant violet is derived from the dioxazine family. Chemically, the material is known as 8,18-dichloro-5,15-diethyl-5,15-dihydrodiindolo [3,2-6:3′,2′-m]phenodioxazine. This pigment is categorized as color index name C.I. Pigment Violet 23 and can be used in the present invention.

There are three yellow organic pigments used in the present invention. The first material is an azo condensation product categorized as color index name C.I. Pigment Yellow 95. Chemically the pigment is 3,3′-{(2,5-dimethyl-1,4-phenylene)bis{imino(1-acetyl-2-oxo-2,1-ethanediyl)azo}}bis{4-chloro-N-(5-chloro-2-methylphenyl)}-benzamide. The second yellow organic pigment used in the present invention is monoazo based and is categorized as color index name C.I. Pigment Yellow 191:1. The pigment is represented chemically as 4-chloro-5-methyl-2-[4,5-dihydro-3-methyl-5-oxo-1(3-sulfonphenyl-1H -pyrazo-4-yl)azo]benzenesulfonic acid ammonium salt.

The third yellow organic pigment used in the present invention is based on the isoindolinone family and is categorized as color index name C.I. Pigment Yellow 110. The chemical identity can best be represented as reaction products of the methyl ester of 2,3,4,5-tetrachloro-6-cyanobenzoic acid with p-phenylenediamine and sodium methoxide. Color index name C.I. Pigment Orange 64 is an orange organic pigment that can be used in the present invention. Chemically the pigment is 5-[(2,3-dihydro-6-methyl-2-oxo -1H-benzimidazol-5-yl)azo]-2,4,6(1H,3H, 5H)-pyrimidinetrione.

There are two organic red pigments that can be used in the present invention. The first is based on quinacridone and is categorized as color index name C.I. Pigment Violet 19. Chemically this pigment is 5,12-dihydroquino[2,3-b]acridine-7,14-dione.

The second red organic pigment that can be used in the present invention is based on diketo-pyrrolopyrrol and is categorized as color index name C.I. Pigment Red 254. The chemical representation is 2,5-dihydro-3,6-di-4-chlorophenylpyrrolo[3,4-c]pyrrol-1,4-dione. These organic pigment dispersions may be used singly or can be blended to color vulcanized rubber particles. Many colors and shades of color are possible by this approach.

A specific embodiment of the present invention involves the preparation of a stable aqueous dispersion of an organic pigment such as copper phthalocyanine in the presence of opacifying pigments exemplified by titanium dioxide and it subsequent use to color vulcanized rubber granules. Rutile grades of titanium dioxide are preferred over anatase grades due to less chalking tendency. The aqueous dispersion optionally may contain other pigments such as zinc oxide and/or silicon dioxide as well as extenders such as calcium carbonate.

Addition of low levels of these types of stable aqueous dispersions of copper phthalocyanine to vulcanized rubber granules followed by efficient mixing results in quite uniform color coverage of the rubber particles. The brightness of the blue rubber particles depends on the amount of titanium dioxide and the amount of extender if used. Generally a brighter and lighter blue coloration is obtained with higher titanium dioxide concentrations. Many aesthetically pleasing shades of blue coloration on rubber particles can be obtained using various ratios of titanium dioxide/calcium carbonate.

The total solids content of stable aqueous organic dispersions of the present invention is in the range of 40 to 60%. The preferred total solids is in the range of 42% to 55%. Of the solids content in a stable aqueous dispersion of copper phthalocyanine used in the present invention, the concentration of copper phthalocyanine ranges 0.90 to 22.50 weight percent. The preferred concentration range for copper phthalocyanine is 1.50 to 14.50 weight percent of the solids content. The concentration of titanium dioxide (and optionally other pigments and/or extenders) ranges from 99.10 to 77.50 weight percent of the solids content, and the preferred concentration range is 98.50 to 85.50 weight percent. The values stated herein are for aqueous organic pigment dispersions that are formulated in the absence elastomer. These concentration values will change if the organic dispersion is formulated in the presence of elastomer.

Aqueous organic pigment dispersions used in the present invention are added to vulcanized rubber granules in concentrations ranging from 0.01 to 8.00 weight percent with respect to the total weight of rubber. A more preferred range of aqueous organic pigment dispersion to be used with the rubber is 0.05 to 6.00 weight percent with respect to the total weight of rubber. A most preferred range of aqueous organic pigment dispersion to be used with the rubber is 0.10 to 5.00 weight percent with respect to the total weight of rubber. Efficient mixing of the aqueous dispersion of colorant with vulcanized rubber granules is essential to achieve uniform color coverage of the rubber particles. On a laboratory scale a helical or cylindrical mixer attached to a motor operating at speeds of 500 to 1700 rpm is sufficient to achieve good mixing and color coverage of the rubber particles. On a large commercial scale, horizontal blenders with ribbon agitators are very efficient for mixing aqueous pigment dispersions onto the rubber particles. It is preferred to have the horizontal mixing chamber and ribbon agitators constructed of stainless steel. Mixing time of 2-3 minutes is generally sufficient to achieve good color coverage in small laboratory equipment. In a 30 cubic foot Marion stainless steel mixer equipped with a stainless steel ribbon agitator excellent color coverage of 700 pounds of vulcanized rubber nuggets was achieved in as little as 5 minutes using 0.25 weight percent aqueous pigment dispersion. Depending on the type of rubber particles used, it may be advisable to use either a paddle or plow agitator instead of a ribbon agitator to achieve good rubber/colorant mixing.

Due to the very non polar and hydrophobic nature of the surface of vulcanized rubber particles, it is difficult to achieve excellent color/rubber adhesion. As discussed, the absence of direct strong bonds between colorant and rubber moieties is responsible for the lack of color adhesion.

A specific embodiment of the present invention is the use of a coating to encapsulate the color onto the rubber particle would provide a means to affix the color. The coating must be integral to provide coverage over the uniform layer of color deposited on the rubber. Ideally, the coating should be very flexible to withstand harsh abrasion forces. The coating should also possess the ability to flex repeatedly with the rubber particle without cracking.

The requirements of an integral coating that is very flexible to affix color onto the vulcanized rubber particles can be met by use of an elastomer. Since the dispersion is applied to rubber particles in aqueous media, subsequent addition of elastomer latex should be an ideal means of applying the elastomer. Drying at somewhat elevated temperature should produce a thin and integral elastomer film that has covered and coated the colored layer and bonded it to the rubber particle. In a way the coated, colored rubber particle may be envisioned as three component laminate structure. The tough and durable exterior elastomer film ensures and protects the uniformity of the color layer that is only weakly bonded to the vulcanized rubber particle. While the color layer on the rubber particle is uniform it is not completely integral so that there are some rubbersites available for direct interaction/binding with the elastomer. Hence, the elastomer film not only protects the color layer but also is itself involved in some direct interaction and binding with the surface of the vulcanized rubber particle.

The elastomer latex can be added in two ways. It can be formulated with the aqueous pigment dispersion and added to the vulcanized rubber particles. Alternatively, the aqueous pigment dispersion can first be added to the vulcanized rubber particles, and the elastomer latex can then be added in a second, separate step. Using the latter technique, there is the advantage that the concentration of the elastomer is independent of that of the pigment. The ability to control the elastomer concentration separately from the pigment concentration may be important in improving color abrasion and durability of certain types of pigments in coloring vulcanized rubber particles.

There are at least two fundamental features of elastomer that need to be considered to meet the requirements herein described to promote color adhesion to vulcanized rubber particles. The first feature is that the chemical structure of the elastomer should possess moieties capable of entering into bonding interactions with the colorant. It may not always be possible to satisfy this feature fully since only minor bonding interactions may be extant. The second feature is that the elastomer should possess a low glass transition temperature (T_{g}).

The glass transition temperature is the temperature at which the amorphous domains of a polymer take on the characteristic properties of the glassy state-brittleness, stiffness, and rigidity. Accordingly, the lower the T_{g} of the polymer the more flexible the polymer chain becomes. Since flexibility of the elastomer coating is very important to protect the color layer, it is critically important that the elastomer possess a quite low T_{g}.

With these criteria in mind, the choice of available elastomers to protect organic pigment layers on vulcanized rubber particles is influenced by the structure of the colorant. In the present invention, use of copper phthalocyanine as an organic pigment to color vulcanized rubber particles points to elastomers in the styrene/butadiene (SBR) family. This is because of structural similarities between SBR and copper phthalocyanine that should promote bonding interactions. Indeed, the aromatic moieties in SBR elastomer should show favorable bonding interactions with the aromatic moieties in copper phthalocyanine. Additionally, there are numerous SBR elastomers that exhibit reasonably low T_{g}.

There are many SBR elastomers available commercially since they are used routinely as an important initial rubber source in tire manufacture. The BF Goodrich Company, Cleveland, Ohio offers a family of SBR latices formulated, for example by carboxylation, to exhibit various degrees of adhesion to substrates. These rubbers exhibit reasonably low glass transition temperatures (−23° C. to +17° C.).

In addition to the use of organic pigments, the present invention also utilizes inorganic pigments to achieve more earth tone types of colors primarily for the landscaping mulch application. These inorganic pigments are based mainly on iron oxides and are available in red and yellow colors. A brown iron oxide based color is available from blending. There are other colors available based on different inorganic oxides.

A functionalized polyacrylate copolymer available from Rohm and Haas Company, Philadelphia, Pa. is effective as a dispersant to form stable aqueous dispersions of the inorganic pigments. The dispersant is referred to as Tamol 1124 (also called Orotan 1124) and is available as an approximate 50% solution in water.

Other variants of anionic polyacrylic acid and esters can be used to disperse inorganic pigments. Anionic surfactants such as sodium dioctylsulfosuccinate, ammonium lauryl sulfate, sodium lauryl sulfate, and sodium dodecylbenzenesulfonate may be used to disperse these inorganic pigments. The effectiveness of the functionalized polyacrylate copolymer and other anionic surfactants may be improved by incorporation of rheological agents such as hydroxyethyl cellulose, carboxymethyl cellulose, and benonite clays. Other materials such as lecithin and polyvinyl pyrrolidone may be incorporated with these anionic surfactants.

There are at least three red iron oxide pigments available that are categorized as color index name C.I. Pigment Red 101 that show slight variations in the basic red color. All pigments in this classification are Fe₂O₃ iron oxide.

There are at least two hydrated iron oxides, FeOOH, that are yellow and are categorized as color index name C.I. Pigment Yellow 42. These yellows are not as brilliant as the three organic yellow pigments described above.

Another inorganic oxide pigment is green chromium (III) oxide. This is represented chemically as Cr₂O₃ and is categorized as color index name C.I. Pigment Green 17.

There are several mixed metal inorganic oxide pigments that can be considered as colorants. These colorants are not simply physical mixtures of various inorganic metal oxides that could segregate. Rather, they have been reacted at high temperature and are homogeneously and ionically interdiffused to form essentially insoluble mixed metal oxide pigment crystals with different crystalline matrices. A rather light yellow mixed phase oxide inorganic pigment is categorized as color index name C.I. Brown 24. This material possesses a rutile crystalline matrix. The formula is represented as (Ti,Cr,Sb)O₂, and the approximate concentrations of metal oxides used in its formation are 85% titanium dioxide, 5% chromium (III) oxide, and 10% antimony oxide.

Another light yellow mixed metal oxide is categorized as color index name C.I. Yellow 53. This material also possesses a rutile crystalline matrix. The formula is represented as (Ti,Ni,Sb)O₂, and the approximate concentrations of metal oxides used in its formation are 80% titanium dioxide, 15% antimony oxide, and 5% nickel oxide.

A light green mixed metal oxide pigment is categorized as color index name C.I. Green 50, and the material possesses a spinel crystalline matrix. This composition is a complicated mixture, and the approximate concentrations of metal oxides used in its formation are 15% cobalt oxide, 35% titanium dioxide, 30% nickel oxide, 15% zinc oxide, and 5% aluminum oxide. The formula can be represented as Co₂TiO₄(Ni,Zn)O—Al₂O₃.

A light blue mixed metal oxide pigment is categorized as color index name C.I. Blue 28, and this material possesses a spinel crystalline matrix. The formula is represented as CoAl₂O₄, and the approximate concentrations of metal oxides used in its formation are 30% cobalt oxide and 70% aluminum oxide.

Another light blue mixed metal oxide pigment is categorized as color index name C.I. Blue 36. This material also possesses a spinel crystalline matrix. The formula is represented as Co(Al,Cr)₂O₄. The approximate concentrations of metal oxides used in its formation are 30% cobalt oxide, 60% chromium (III) oxide, and 10% aluminum oxide.

Another specific embodiment of the present invention involves the preparation of a stable aqueous dispersion of an inorganic pigment such as iron oxide and its subsequent use in coloring vulcanized rubber granules. The aqueous dispersion optionally may contain other pigments such as titanium dioxide, zinc oxide and/or silicon dioxide as well as extenders such as calcium carbonate.

Addition of low levels of these types of stable aqueous dispersions of red iron oxide to vulcanized rubber granules gives uniform coloring, and subtle shades of earth tone red are possible using the different iron oxide grades. Optional use of titanium dioxide with red iron oxide lightens the coloration slightly. Addition of titanium dioxide pigment is preferred with the lighter inorganic pigment dispersion to attenuate the inherent black coloration of the vulcanized rubber particles. In some cases extension with calcium carbonate can be used to lower overall pigment costs.

The total solids content of stable aqueous inorganic dispersions of the present invention is in the range of 35% to 55%. The preferred total solids is in the range of 37% to 50%. Of the solids content in a stable aqueous dispersion of iron oxide used in the present invention, the concentration of iron oxide ranges 60 to 100 weight percent. The preferred concentration range for iron oxide is 73 to 100 weight percent. The concentration of titanium dioxide (and optionally other pigments and/or extenders) when used ranges from 27 to 40 weight percent. It is understood that it can be rather common practice to use the inorganic oxide pigment alone without the use of titanium dioxide and/or extenders as the active colorant in aqueous inorganic dispersions.

Binding of inorganic pigments to vulcanized rubber particles is marginal due to the weak interactions between the metal atoms and the unshared pairs of electrons on the oxygen atoms with the available sulfur and residual unsaturation sites on the vulcanized rubber. The extent of binding may be less than that extent with organic pigments.

The structure of iron oxide, for example, is not as conducive to electronic interactions with elastomers such as SBR as is the case for copper phthalocyanine. With the prospects for significant electronic interactions between elastomer and iron oxide diminished, it is evident that a different factor in elastomer choice to provide color adhesion of iron oxide and other inorganic pigments to vulcanized rubber particles is necessary.

In the present invention, use of iron oxide as an inorganic pigment to color vulcanized rubber particles requires a tough, integral elastomeric film with a very low glass transition temperature. The elastomer film must be extremely flexible capable of exhibited substantial deformation and recovery. With the lack of significant bonding interactions between elastomer and iron oxide, a tough and very elastic elastomeric film is required to encapsulate the colored rubber particle. Further, since the iron oxide coating is not completely uniform, there are sites available for direct bonding of the elastomer to the vulcanized rubber.

These types of requirements and restrictions to achieve color adhesion and abrasion resistance of inorganic pigments to vulcanized rubber point to the use of acrylic or other elastomers with very low T_{g} values in the present invention. The BF Goodrich Company, Cleveland, Ohio offers a family of acrylic latices designed to exhibit outstanding adhesion properties to substrates due to their very low T_{g} values. Specially designed acrylic elastomer in this family exhibits a T_{g} as low as −60° C. Other acrylic elastomers are available with low glass transition values ranging from −43° C. to −23° C. Certain polybutadiene (PBD) elastomers also exhibit very low T_{g} a values.

All of the binding interactions between elastomer/colorant/vulcanized rubber particles should be enhanced by the application of heat as in, for example, the drying step. Accordingly, performance characteristics such as tendency for color to leach into hot water (color stability) should improve upon the application of heat. In the laboratory, portions of the colored and coated nuggets are air dried and oven dried. In manufacturing operations such as use of large blenders equipped with ribbon, paddle or plow agitators, drying can be accomplished in the blender itself after the addition of the pigment dispersion and elastomer latex if a heated jacketed device is used. This is because the concentration of water in the mixture is quite low, generally not greater than 3-4 weight percent. In this scenario, the heated jacket is adjusted such that the temperature of the mixture (90-95° C.) is close to the boiling point of water. This, then, would provide an environment wherein the rubber particles are heated prior to addition of colorant and elastomer. This method may be favorable for the process of coloring and subsequent treatment with elastomer.

Alternatively, the colored and coated particles can be removed from an unjacketed blender and dried separately using a vibrating conveyor belt passing through a bank of infrared heaters, a fluid bed dryer, or other conventional means of drying large quantities of materials. The choice of these production methods will depend on overall product quality, production volumes, and comparative economics.

In order to demonstrate practices of the present invention, the preparation of aqueous organic pigment dispersion, its use in coloring vulcanized rubber granules, and coating of the colored rubber particles with elastomers are described. The preparation of aqueous inorganic pigment dispersion, its use in coloring vulcanized rubber granules, and coating of resulting colored rubber particles with elastomers also are described.

Preparation of Aqueous Pigment Dispersions

For the copper phthalocyanine dispersion, the following recipe is used. To a 600 ml beaker equipped with a magnetic stirring bar are added 1.00 g Tergitol 15-S-9 and 75.00 g distilled water. (Tap water also can be used in these formulations but distilled water is preferred.) The mixture is stirred on a magnetic stirrer until homogeneous and one drop Dow FG 10 antifoam is added to eliminate the foam head. Copper phthalocyanine, 5.00 g, is slowly added over three minutes with good agitation until a good dispersion (deep dark blue coloration) is achieved. To this mixture are then added over five minutes with good agitation 32.00 g calcium carbonate (Omyacarb UF) and 32.00 g titanium dioxide (Kronos 2020 Rutile Grade). The resulting dispersion is a medium robin egg blue.

One weight percent of this organic dispersion is used to color vulcanized rubber particles. The dispersion is always shaken or stirred before each use. The resulting aqueous dispersion is stable and shows practically no settling on standing at room temperature for 24 hours. Long term storage stability of the dispersion likely would be improved by using more efficient, higher speed mixing.

For the red iron oxide dispersion, the following recipe is used. To a 600 ml beaker equipped with a magnetic stirring bar are added 0.90 g Orotan 1124, 0.10 g bentonite clay (Suspengel Elite), and 75.00 g distilled water. The mixture is stirred on a magnetic stirrer until homogeneous (very slight haze) and one drop Dow FG 10 antifoam is added to eliminate the foam head. Red iron oxide (Bayer Corporation, Pittsburgh, Pa.), 75.00 g. is added slowly over five minutes. The resulting dispersion is a deep dark orange red.

One weight percent of this inorganic dispersion is used to color vulcanized rubber particles. The dispersion is always shaken or stirred before each use. The resulting aqueous dispersion is stable and shows little settling on standing at room temperature for 24 hours. Long term storage stability of the dispersion likely would be improved by using more efficient, higher speed mixing.

Coloring and Elastomer Coating of Vulcanized Rubber Particles

A shaft connected to a cylindrical mixer is attached to a drill press. The cylindrical mixer is ribbed and measures 3.72 inches high with a diameter of 3.09 inches. Changing the size of the pulleys connected by a belt can alter the speed of the drill press. The speed is set to 500 rpm. To a high density polyethylene 11 quart pail is added 1350 g rubber nuggets which measure approximately ⅜ of an inch. The pail containing the nuggets is positioned so that the bottom of the cylinder is about one half inch from the bottom of the pail. One weight percent (with respect to the weight of rubber nuggets) of copper phthalocyanine aqueous dispersion, 13.5 g, is added and is mixed with the nuggets for three minutes. During this time the pail is moved about the stirrer to maximize the contact between the rubber nuggets and the aqueous dispersion. At the end of this time the color coverage was quite uniform, and the rubber nuggets were colored medium robin egg blue.

Elastomer latex was immediately added after coloring. In the case of SBR, 10 g of rubber (18.83 g of latex, 53.1% total solids) was added after the latex was diluted with 20 g of water. Stirring continued an additional two minutes after the diluted elastomer latex was added. In the case of acrylic elastomer, 10 g of rubber (20.24 g of latex, 49.4% total solids) was added after the latex was diluted with 20 g of water. Stirring continued an additional two minutes after the diluted elastomer latex was added.

The coloring procedure was repeated except that one weight percent, 13.5 g, of red iron oxide aqueous dispersion was added to 1350 g rubber nuggets. Color coverage was again quite uniform, and the rubber nuggets were colored dark orange red after three minutes of stirring. The colored rubber particles were coated with 10 g SBR as described for the case using copper phthalocyanine. The colored rubber particles also were coated with 10 g acrylic rubber. The same elastomer coating procedure as described for the case of copper phthalocyanine was used. It is anticipated that this same type of approach to coloring and subsequent elastomer coating of vulcanized rubber granules should be applicable to many different types of colorants and elastomers.

The coloring and coating experiments are summarized in Table I.

TABLE I
Coloring and Elastomer Coating of Vulcanized Rubber Particles^{1,2}

| | | Colorant Concentration | | |
|---|---|---|---|---|
| | | Added | | |
| Expt No | Colorant | to Rubber Nuggets wt. % | Elastomer³ | T_{g}° C |
| 1 | Copper | 0.03448 | SBR | −23 |
| | Phthalocyanine | | | |
| 2 | Copper | 0.03448 | acrylic | −43 |
| | Phthalocyanine | | | |
| 3 | Red Iron Oxide | 0.4967 | SBR | −23 |
| 4 | Red Iron Oxide | 0.4967 | acrylic | −43 |

¹1350 g of ⅜ inch rubber nuggets (source: Tire Depot, Inc., Morehead, MN) colored and coated.
²Elastomer, 0.7404 wt. %, added to rubber nuggets in second step.
³Elastomer source: The BF Goodrich Company, Cleveland, Ohio.

Each of the color and coated vulcanized rubber products are dried two different ways—a portion is air dried at room temperature for 18 hours and another portion is oven dried at 110-120° C. for ten minutes. The color stability test involves heating and stirring dried color and coated nuggets in water to ˜75-80° C. from room temperature over 15 minutes and observing the color/clarity of the aqueous effluent. The color abrasion test involves taking several nuggets, rubbing them vigorously on a white paper background, and observing if the color rubs off onto the paper. Both the color stability and abrasion tests are very severe, much more so than would be observed in normal use conditions.

As a general rule, it is observed that the color of the air dried nuggets does not change when the nuggets are oven dried.

The results of color stability and color abrasion testing for air dried and oven dried colored and coated vulcanized rubber particles are summarized in Table II.

TABLE II
Color Stability and Abrasion Resistance of Colored and Coated Vulcanized Rubber
Products

| | Method of Drying | | Appearance of Aqueous | |
|---|---|---|---|---|
| | Air Dry @ | Oven Dry @ | Effluent from | Color |
| Expt. No.¹ | Rm Temp. 18 hrs | 110-120° C. | Color Stability Test² | Abrasion Test³ |
| 1 | x | | v. slight haze; no color | color does not |
| | | | | rub off |
| 1 | | x | essentially clear; no color | color does not |
| | | | | rub off |
| 2 | x | | slight haze; no color | color does not |
| | | | | rub off |
| 2 | | x | almost clear; no color | color does not |
| | | | | rub off |
| 3 | x | | hazy and dark red | color rubs off |
| 3 | | x | hazy and red | less color rubs |
| | | | | off than oven |
| | | | | dry |
| 4 | x | | clear; very light pink | color does not |
| | | | | rub off |
| 4 | | x | clear; almost colorless | color does not |
| | | | | rub off |

¹Experiment numbers and materials are the same as those in Table I.
²Colored and coated nuggets (20 g) added to 200 g water; mixture heated with stirring from ambient temperature to ˜80° C. over 15 minutes.
³Colored and coated nuggets rubbed vigorously on white paper background.

It is evident from Table I that the concentration of copper phthalocyanine used to color vulcanized rubber particles is far less than the concentration of red iron oxide used. This reflects a higher coloring capacity of copper phthalocyanine compared to red iron oxide. Indeed the concentration of red iron oxide used on a weight basis is 14.4 times that of copper phthalocyanine. Since the same weight percentage of both SBR and acrylic rubber was used to coat the pigments, it is apparent that the relative ratio of rubber to pigment is much higher in the case of copper phthalocyanine. The rubber/pigment ratios are 21.47 and 1.49 for copper phthalocyanine and red iron oxide, respectively. Hence, the elastomer layer covering copper phthalocyanine colored vulcanized rubber particles is thicker than the elastomer layer covering the red iron oxide.

From the data in Table II is apparent that application of heat to dry the colored and coated vulcanized rubber particles is beneficial for the color stability for all combinations of pigment and elastomer tested. Accordingly, use of heat to dry to colored and coated particles is preferred to simply allowing the particles to air dry.

It is significant that copper phthalocyanine is not extracted into hot (˜80° C.) water regardless of whether the colored and coated rubber particles are air dried or oven dried. The haze observed in the aqueous effluent for oven dried samples is due to some extraction of titanium dioxide and/or calcium carbonate into the effluent. It is especially interesting the blue color does not rub off particles that are either air or oven dried. This suggests that the elastomer coating over the copper phthalocyanine layer while thick is quite uniform. While differences between the coating performance of SBR and acrylic rubber are minimal for copper phthalocyanine, the use of SBR over acrylic rubber is slightly preferred. This might be due to more effective electronic interactions between SBR elastomer and copper phthalocyanine than between acrylic elastomer and copper phthalocyanine.

In contrast to the data for copper phthalocyanine, the situation for use of red iron oxide is quite different. The performance of SBR elastomer is far inferior to that of acrylic elastomer in protecting red iron oxide in terms color stability and color abrasion resistance. Whether the product is air dried or oven dried, there is considerable haze in the water effluent after the hot (80° C.) water color stability test. Color abrasion with the SBR coating on red iron oxide also is inferior. The color rubs off easily for the air dried sample, and there is still some color rub off for the oven dried sample.

The acrylic rubber coating offers good protection for red iron oxide. The color stability test gave a clear aqueous effluent for both air and oven dried samples. There is a very light pink coloration in the aqueous effluent for the air dried sample, and almost no color in the aqueous effluent for the oven dried sample. Color abrasion was good for both the air dried and oven dried materials since the color did not rub off in either case.

The lack of color stability and poor abrasion resistance for vulcanized rubber particles colored with red iron oxide and coated with SBR elastomer suggests that bonding interactions between the elastomer and the pigment are poor. There is little opportunity for significant bonding between iron oxide and SBR elastomer.

The superior performance of the acrylic rubber compared to that of SBR for protecting red iron oxide is likely not a consequence of bonding interactions since these also are relatively minor for the acrylic rubber/pigment situation. Rather, the encouraging results with acrylic elastomer protecting red iron oxide pigment may be due to the quite low T_{g} of the acrylic elastomer (−43° C.). This T_{g} is considerably lower than the T_{g} of the SBR elastomer (−23° C.). The lower the T_{g} of the polymer, the more elastic and flexible the polymer. The lower T_{g} of the acrylic elastomer may promote a tough, integral and flexible film coating that resists cracking under an applied load such as severe abrasion.

Neither SBR nor acrylic elastomer possesses structural moieties that promote strong bonding interactions with iron oxide. The fact that the acrylic elastomer with its lower T_{g} compared to that of the SBR elastomer demonstrates far superior protection to iron oxide pigment in terms of color stability and color abrasion resistance may point to the requirement of a minimum T_{g} essential for formation of a tough, integral and flexible film. SBR elastomer may have failed to protect the iron oxide because its T_{g} is not sufficiently low. Under an applied load, SBR elastomer with a T_{g} of only −23° C. may not be sufficiently flexible to prevent film cracking that leads to pigment loss from the particle. On the other hand, acrylic elastomer with a T_{g} of −43° C. may provide a more flexible and durable film that seals and does not crack under the applied load thereby keeping the pigment intact. Hence, the ability to protect the integrity of inorganic pigments such as red iron oxide on the rubber particle from loss due to extraction by hot water and abrasion resistance may be a consequence of structural units in the polymer responsible for a minimum T_{g} rather than polymer structural units that promote bonding. This minimum T_{g} for the polymer may be between −23and −43° C. to afford protection needed when inorganic pigments are used to color vulcanized rubber particles.

It should now be evident that many different organic and inorganic pigments can color vulcanized rubber particles in the present invention. It is especially significant that subsequent use of elastomers is key in protecting the integrity of the pigment coloring onto rubber particles. It is also clear that the type of elastomer used to maximize color stability and color abrasion resistance of the vulcanized rubber particles depends on the type of pigment used. In some cases inherent structural features of the elastomer promote electronic/steric interactions with the pigment, and these are the dominant themes that guide rubber choice for optimum preservation of color stability and color abrasion resistance. In other cases elastomer structural features responsible for the attainment of very low glass transition temperature (T_{g}) to give tough, integral and very flexible films to coat/seal pigment to the vulcanized rubber particle are key for optimum preservation of color stability and color abrasion resistance.

Thus, it is believed that any of the variables disclosed herein can readily be determined and controlled without departing from the scope of the invention herein disclosed and described. Moreover, the scope of the invention shall include all modifications and variations that fall within the scope of the attached claims.

What is claimed is:

1. A process for preparing colored vulcanized rubber granules comprising:
adding aqueous pigment dispersion to uncolored vulcanized rubber granules;
mixing said pigment and rubber granules a first predetermined period of time at ambient temperature to achieve uniform color coverage onto said vulcanized rubber granules to thereby form colored vulcanized rubber granules;
adding elastomer latex to said colored vulcanized rubber granules;
mixing said elastomer latex and said colored vulcanized rubber granules a second predetermined period of time at ambient temperature to achieve uniform rubber coating onto colored vulcanized rubber granules to thereby form rubber coated colored vulcanized rubber granules; and
drying said rubber coated colored vulcanized rubber granules for a third predetermined period of time.

2. The process of claim 1, wherein the first predetermined period of time is between about 1 to 10 minutes.

3. The process of claim 1, wherein the second predetermined period of time is between about 3 to 8 minutes.

4. The process of claim 1, wherein the drying step is accomplished at a temperature range between about 90-120° C.

5. The process of claim 1, wherein the drying step occurs at ambient temperature.

6. The process of claim 1, wherein the aqueous pigment dispersion is added to vulcanized rubber particles in a concentration range of 0.01 to 5.00 weight percent with respect to the amount of rubber used.

7. The process of claim 1, wherein the elastomer latex is added to vulcanized rubber particles contacted with aqueous pigment dispersion at a concentration range of 0.01 to 4.00 weight percent with respect to the amount of rubber used.

8. The process of claim 1, wherein the concentration of water in the mixture is in the range of 0.01 to 5.00 weight percent.

9. The process of claim 1, wherein the aqueous pigment dispersion is comprised of an organic pigment, an opacifying pigment such as titanium dioxide, zinc oxide or silicon dioxide and optionally an extender such as calcium carbonate.

10. The process of claim 9, wherein the total solids content of the aqueous organic pigment dispersion is in the range of 35 to 55 weight percent.

11. The process of claim 1, wherein the elastomer latex is styrene/butadiene (SBR) rubber optionally modified by the addition of hydroxyl and/or carboxyl groups.

12. The process of claim 1, wherein the elastomer latex is polybutadiene (PBD) rubber.

13. The process of claim 1, wherein the elastomer latex is acrylic rubber optionally modified by co and/or terpolymerization.

14. The process of claim 13, wherein the acrylic rubber has a glass transition temperature (T_{g}) in the range −13° C. to −70° C.

15. A method of preparing colored rubber particles, comprising:
mixing vulcanized rubber particles with an aqueous pigment dispersion to form a mixture;
stirring said mixture to color coat said rubber particles to thereby form color coated rubber particles;
adding an elastomer latex to the mixture to encapsulate said color coated rubber particles; and
drying said encapsulated rubber particles to thereby form a protective film around said color coated rubber particles.

16. The process of claim 15, wherein said step of adding said elastomer latex is a step separate from the mixing step.

17. The process of claim 15, wherein said pigment comprises an organic pigment.

18. The process of claim 15, wherein said pigment comprises an inorganic pigment.

19. The process of claim 17, wherein said aqueous organic pigment dispersion has a total solids content of about 40 to 60 percent.

20. The process of claim 15, wherein said elastomer comprises styrene/butadiene rubber.

21. The process of claim 18, wherein said aqueous inorganic pigment dispersion further comprises an opacifying pigment and an extender.

22. The process of claim 18, wherein said elastomer comprises a functionalized polyacrylate multipolymer.

23. The process of claim 18, wherein said aqueous inorganic polymer dispersion further comprises an anionic surfactant.

24. The process of claim 23, wherein said inorganic pigment dispersion further comprises an extender and an opacifying pigment.

25. A playground surface material comprising:
vulcanized rubber particles;
a color coating covering and adhering to said vulcanized rubber particles to thereby form color coated vulcanized rubber particles; and
an elastomer encapsulating said color coated vulcanized rubber particles.

26. The playground surface material of claim 25, wherein said color coating comprises an organic pigment.

27. The playground surface material of claim 26, wherein said color coating further comprises an opacifying pigment.

28. The playground surface material of claim 25, wherein said color coating further comprises an extender.

29. The playground surface material of claim 25, wherein said elastomer comprises a styrene/butadiene rubber.

30. The playground surface material of claim 25, wherein said color coating comprises an inorganic pigment.

31. The playground surface material of claim 29, further comprising an anionic surfactant and an opacifying pigment.

32. The playground surface material of claim 31, wherein said elastomer comprises a functionalized polyacrylate multipolymer.

33. The playground surface material of claim 31, wherein said color coating further comprises an extender.
